(19) United States
(12) Patent Application Publication
(10) Pub. No.: US 2014/0354896 A1
(43) Pub. Date: Dec. 4, 2014

(54) TOUCH PANEL

(71) Applicant: TIANJIN FUNAYUANCHUANG TECHNOLOGY CO., LTD., Tianjin (CN)

(72) Inventors: PO-SHENG SHIH, New Taipei (TW); JIA-SHYONG CHENG, New Taipei (TW)

(21) Appl. No.: 13/903,001

(22) Filed: May 28, 2013

(51) Int. Cl. G06F 3/044

(52) U.S. Cl. CPC G06F 3/044
USPC 349/12

(57) ABSTRACT

A capacitive touch panel includes an insulated substrate, a first conductive film and a second conductive film. The insulated substrate includes a first surface and a second surface. The first conductive film and the second conductive film are anisotropic in their electrical resistance. The first conductive film is located on the first surface of the insulated substrate. The second conductive film is located on the second surface of the insulated substrate. A minimum electrical resistance direction of the first conductive film is perpendicular to a minimum electrical resistance direction. At least one of the first conductive film and the second conductive film is a carbon nanotube film.

### BACKGROUND

1. Technical Field

The present disclosure relates to touch panels, particularly to a carbon nanotube based touch panel.

2. Description of Related Art

A number of electronic apparatuses are equipped with optically transparent touch panels in or on their display devices such as liquid crystal panels. A user can operate the electronic apparatus by pressing a touch panel with a finger or a stylus while visually observing the display device through the touch panel. Touch panels that are superior in visibility and reliable in operation are required. Due to a higher accuracy and sensitivity, capacitance touch panels have been used.

A conventional multipoint capacitance touch panel includes a substrate, a plurality of parallel first strip-shaped transparent conductive layers located on a first surface of the substrate, and a plurality of parallel second strip-shaped transparent conductive layers located on a second surface of the substrate opposite to the first surface. The first strip-shaped transparent conductive layers are intercrossed with the second strip-shaped transparent conductive layers. However, the first strip-shaped transparent conductive layers and the second strip-shaped transparent conductive layers are made of indium tin oxide (ITO) layers generally formed by means of ion-beam sputtering. This method is complicated. Furthermore, the ITO layers are located on both the first and second surfaces of the substrate, thus the structure of the multipoint capacitance touch panel is complex to construct and complicated in form.

What is needed, therefore, is to provide a touch panel which can overcome the shortcoming described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic top view of one embodiment of a touch panel.

FIG. 2 is an exploded view of the touch panel in FIG. 1.

FIG. 3 is a schematic, cross-sectional view, along a line of FIG. 1.

FIG. 4 is a scanning electron microscope (SEM) image of a carbon nanotube film.

FIG. 5 shows a first conductive film and a second conductive film which are coupled to a reading circuit and a driving circuit respectively, to establish the touched point.

FIG. 6 is a schematic view of the working principle of the touch panel of FIG. 1.

FIG. 7 is a scanning sequence chart of the touch panel of one embodiment.

FIG. 8 shows a wave form of the reading signal of the touch panel of one embodiment when not touched.

FIG. 9 shows a wave form of a reading signal of the touch panel of one embodiment when touched.

FIG. 10 shows a numeric curve after one scanning period of the touch panel of one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

References will be made to the drawings to describe various embodiments of the present capacitance touch panels.

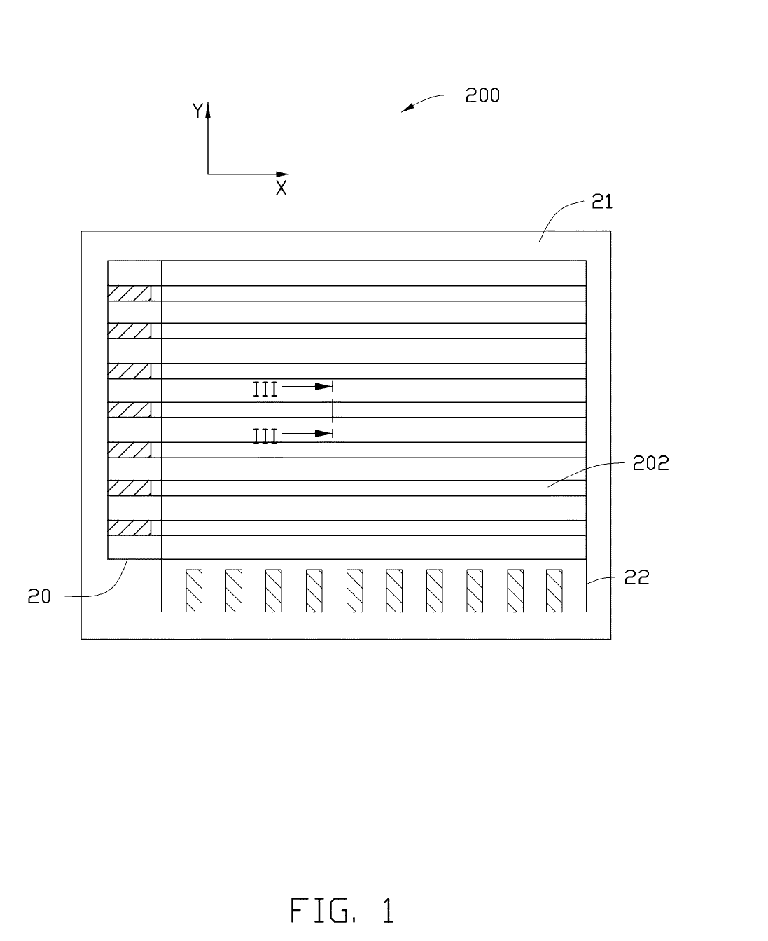

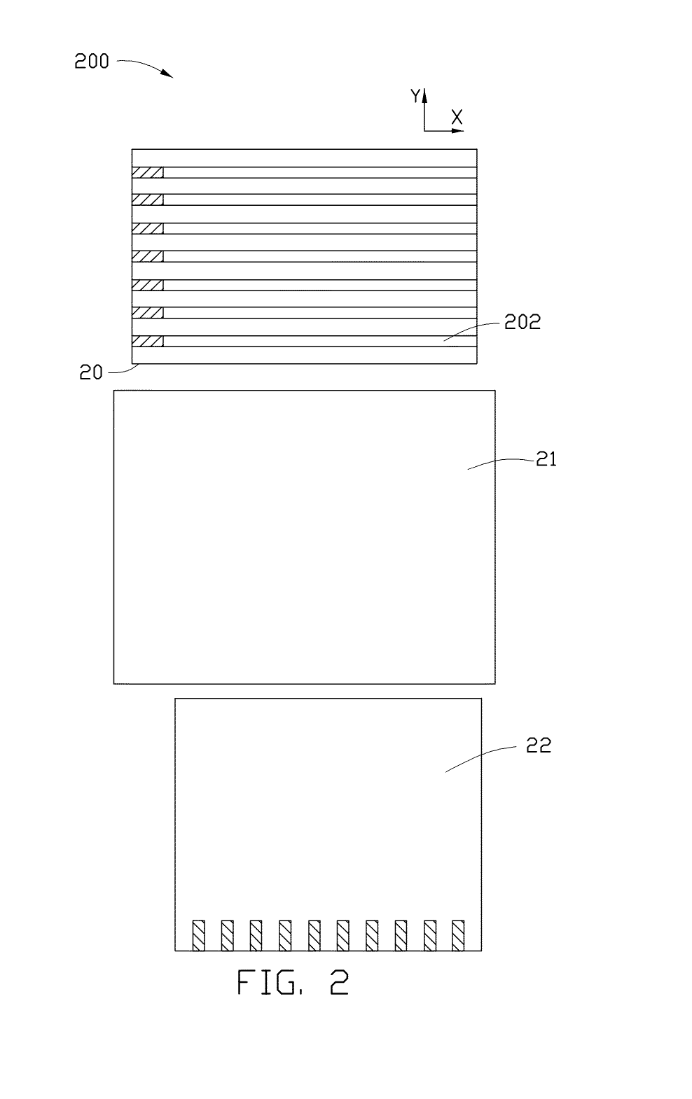

Referring to FIGS. 1 and 2, a touch panel 200 of one embodiment includes a first conductive film 20, a second conductive film 22, and an insulated substrate 21. The insulated substrate 21 is sandwiched between the first conductive film 20 and the second conductive film 21. The touch panel 200 is a capacitance touch panel.

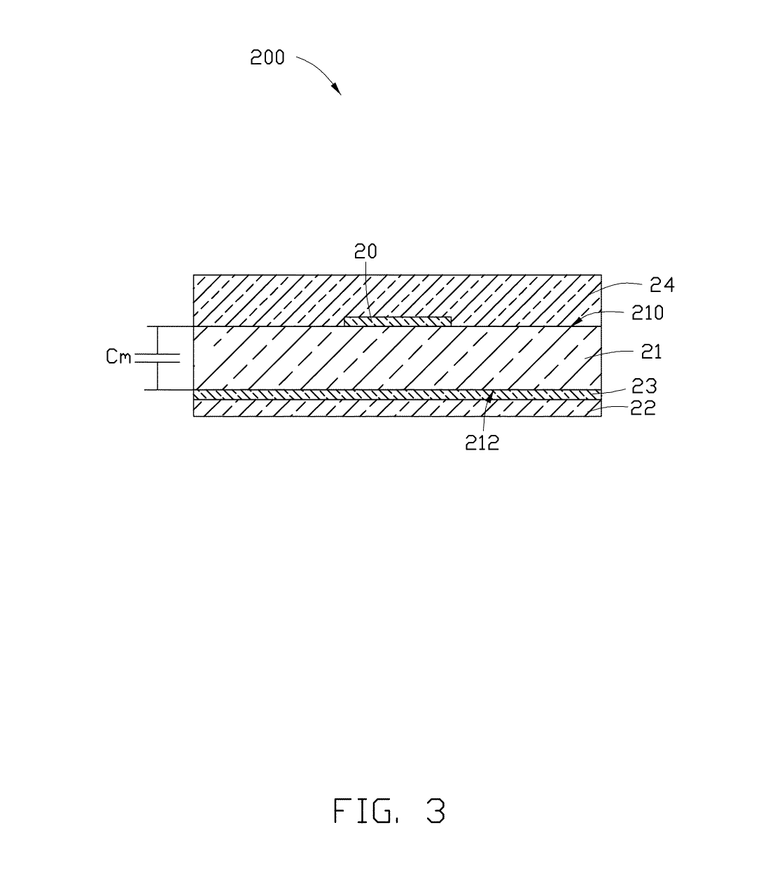

Referring to FIG. 3, the insulated substrate 21 includes a first surface 210 and a second surface 212 opposite to each other. The first conductive film 20 is located on the first surface 210 of the insulated substrate 21. The second conductive film 22 is located on the second surface 212 of the insulated substrate 21. The first conductive film 20 and the second conductive film 22 are anisotropic in their electrical resistance (electrical resistance anisotropy). The minimum electrical resistance direction of the first conductive film 20 is perpendicular to the minimum electrical resistance direction of the second conductive film 22.

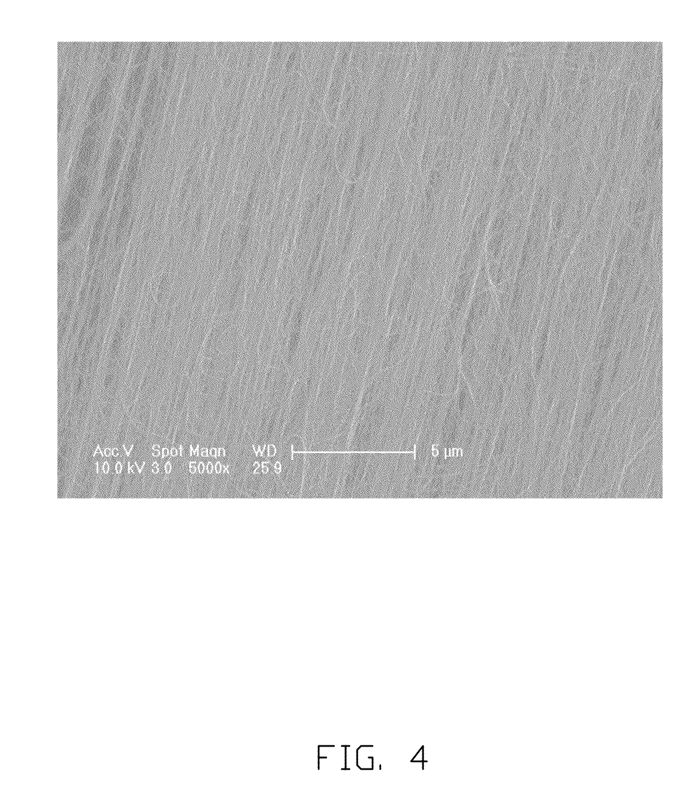

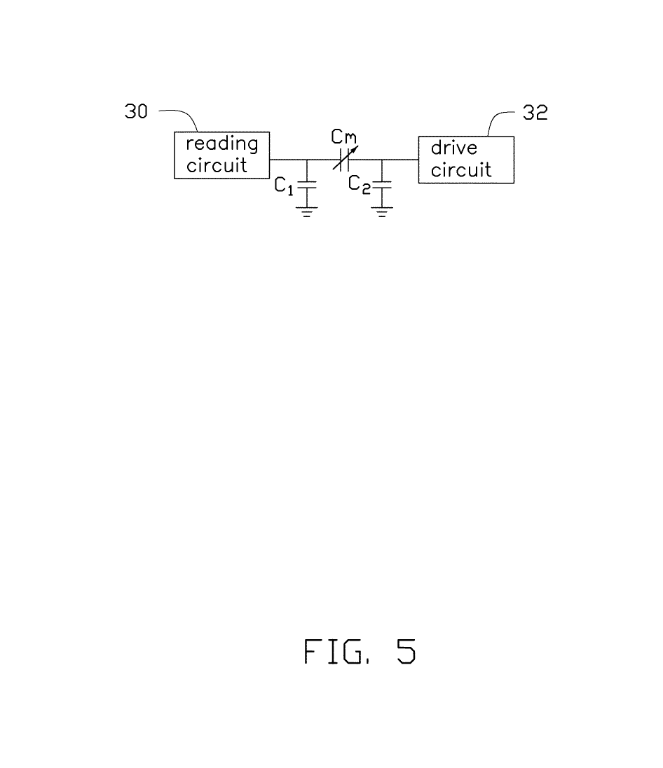

The first conductive film 20 includes a plurality of patterned conductive structures, such as strip-type conductive structures 202. The strip-type conductive structures 202 are parallel to and distanced from each other. In one embodiment, the first conductive film 20 is a patterned ITO film. The first conductive film 20 can be other conventional materials or patterned electrical resistance anisotropy films. In one embodiment, a ratio between a width of the strip-type conductive structure 202 and a distance between the adjacent strip-type conductive structures 202 is, but is not limited to, 5%-50%. In one embodiment, the distance between the adjacent strip-type conductive structures 202 is 5 millimeters (mm), the width of the strip-type conductive structure 202 is about 0.25-2.5 mm. The strip-type conductive structures 202 extend along a first direction (the X axis in FIG. 4 and FIG. 5); so as to create a minimum electrical resistance along a first direction of the first conductive film 20.

The insulated substrate 21 provides support to the first and the second conductive films 20, 22. The insulated substrate 21 has a planar structure and is transparent. The insulated substrate 21 can be made of hard materials, such as glass, quartz, or diamond. The insulated substrate 21 can also be made of soft materials, such as plastic or resin. When the insulated substrate 21 is made of soft materials, the soft materials can be polycarbonate (PC), polymethylmethacrylate (PMMA), polyethylene terephthalate (PET), polyether sulfone (PES), cellulose ester, Benzocyclobutene (BCB), polyvinylchloride (PVC), or acrylic resin. In one embodiment, the material of the insulated substrate 21 is glass, with a thickness of 1 millimeter. The material of the insulated substrate 21 is not limited to the content of the above descriptions, all transparent insulated substrates 21 which have a supporting function are within the protection of the present disclosure.

The second conductive film 22 has a minimum electrical resistance along a second direction (Y axis in FIG. 4 and FIG. 5), and has a maximum electrical resistance along the first direction (X axis in FIG. 4 and FIG. 5). Generally, the electrically conductive direction of the conductive structures 202 of the first conductive film 20 is perpendicular to the direction of the minimum electrical resistance of the second conductive film 22. In one embodiment, the second conductive film 22 is a carbon nanotube (CNT) film.

An SEM image of the carbon nanotube film is shown in FIG. 4. The carbon nanotube film includes a plurality of carbon nanotubes substantially in parallel with each other and arranged to extend along the same direction. A majority of the carbon nanotubes are arranged to extend along the direction substantially parallel to the surface of the carbon nanotube film. The carbon nanotubes in the carbon nanotube film can be single-walled, double-walled, or multi-walled carbon nanotubes. The length and diameter of the carbon nanotubes can be selected according to need, for example the diameter can be in a range from about 0.5 nanometers to about 50 nanometers and the length can be in a range from about 200 nanometers to about 900 nanometers. The thickness of the carbon nanotube film can be in a range from about 0.5 nanometers to about 100 micrometers, for example in a range from about 10 nanometers to about 200 nanometers.

The carbon nanotube film is electrical resistance anisotropy. The carbon nanotube film has a minimum electrical resistance along the extending direction of the plurality of carbon nanotubes, and a maximum electrical resistance along a direction perpendicular to the extending direction of the plurality of carbon nanotubes. A majority of the carbon nanotubes are arranged to extend along a minimum electrical resistance direction, and a minority of the carbon nanotubes are arranged randomly, so that the carbon nanotube film has greatest conductivity along the minimum electrical resistance direction.

Referring to FIG. 3, the second conductive film 22 adheres on the second surface 212 of the insulated substrate 21 via an adhesive 23. The adhesive 23 is transparent. The second conductive film 22 directly adheres on the second surface 212 of the insulated substrate 21 via the adhesive 23. Because the adhesive 23 is transparent, no other element is needed. Not only is the structure of the touch panel 200 simplified, but the transparency of the touch panel 200 is also increased. The adhesive 23 can be pressure sensitive adhesive, heat sensitive adhesive, or light sensitive adhesive. The thickness of the adhesive 23 should not be too thick, and is suitable in a range from 4 micrometers to 8 micrometers. In one embodiment, the adhesive 23 is an UV adhesive with a thickness of 5 micrometers.

In one embodiment, the first conductive film 20 and the second conductive film 22 can have a same structure, which is made of a carbon nanotube film, and both films adhere directly on their respective surface. The alignment directions of the carbon nanotubes in the first conductive film 20 and the second conductive film 22 are perpendicular to each other.

Referring to FIG. 3, the touch panel 200 can also include a protect layer 24 covering the first conductive film 20. The protect layer 24 can be conventional transparent insulated materials, such as Polyethylene (PE), Polycarbonate (PC), Polyethylene Terephthalate (PET), PolyMethyl MethAcrylate (PMMA), or thin glass.

A capacitive structure of the touch panel 200 is shown in FIG. 3. When the first conductive film 20 is touched by user's hand, the electrical field between the first conductive film 20 and the second conductive film 22 receives interference, and the capacitor value Cₘ of the capacitor structure of the touch panel 200 is changed correspondingly. The distance between the adjacent long strip-type conductive structures 202 would increase the electrical field interference level between the first conductive film 20 and the second conductive film 22. Thus, the sensitivity of the touch panel 200 is increased. In one embodiment, the width of the long strip-type conductive structure 202 and the distance between the adjacent long strip-type conductive structures 202 is a range from about 10% to about 20%, in which arrangement the sensitivity of the touch panel 200 is highly increased.

Referring to FIG. 5, when the first conductive film 20 and the second conductive film 22 are coupled to a reading circuit 30 and a driving circuit 32 respectively, the touch point can be detected by detecting the capacitive changes. A first capacitor C₁ represents the capacitance value between the first conductive film 20 and ground. A second capacitor C₂ represents the capacitance value between the second conductive film 22 and ground. In one embodiment, the first conductive film 20 is coupled to the reading circuit 30; the second conductive film 22 is coupled to the driving circuit 32. In another embodiment, the first conductive film 20 is coupled to the driving circuit 32; the second conductive film 22 is coupled to the reading circuit 30.

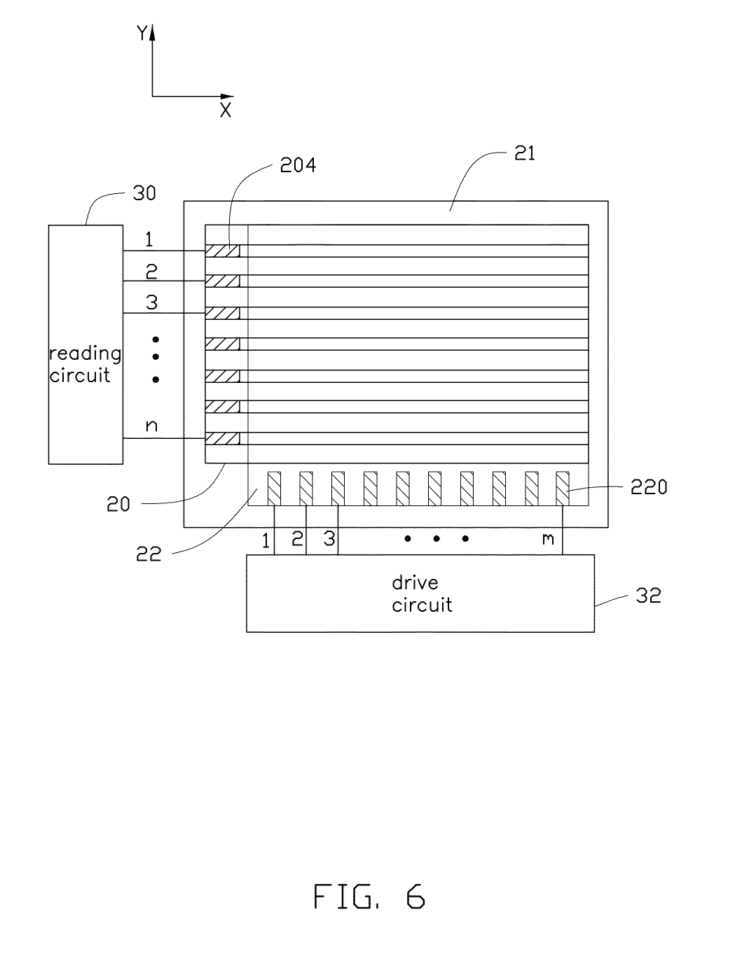

Referring to FIG. 6, a method of one embodiment for detecting the touched point is illustrated. A plurality of first electrodes 204 is installed on one side of the first conductive film 20 along the minimum electrical resistance direction, coupled to the reading circuit 30 as a reading terminal via a plurality of reading lines 1, 2, 3 . . . , n. The n represents the number of reading lines. A plurality of second electrodes 220 is installed on one side of the second conductive film 22 along the minimum electrical resistance direction, coupled to the driving circuit 32 as a scanning terminal via a plurality of scanning lines 1, 2, 3 . . . , m. The m represents the number of scanning lines.

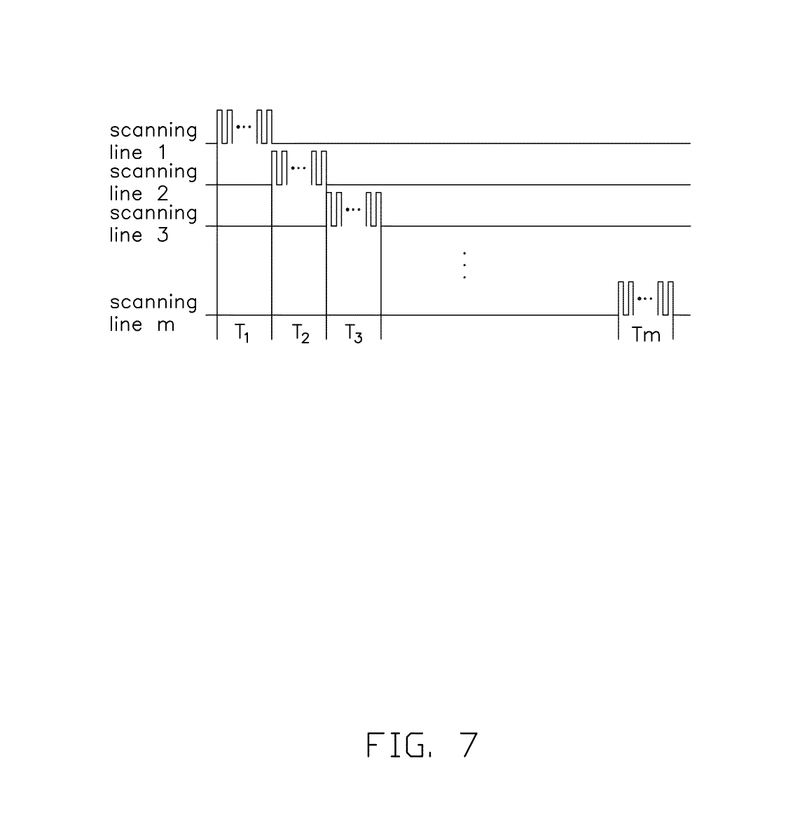

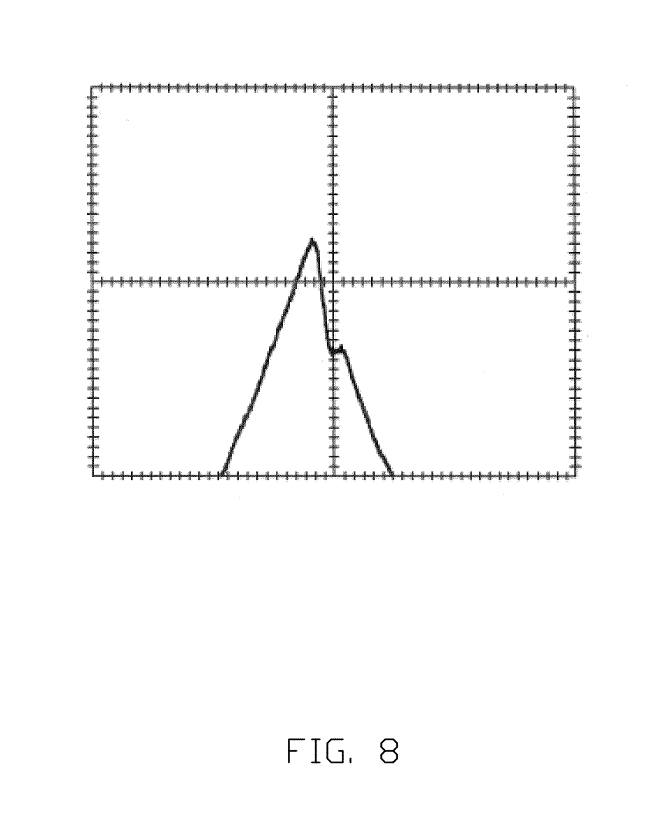

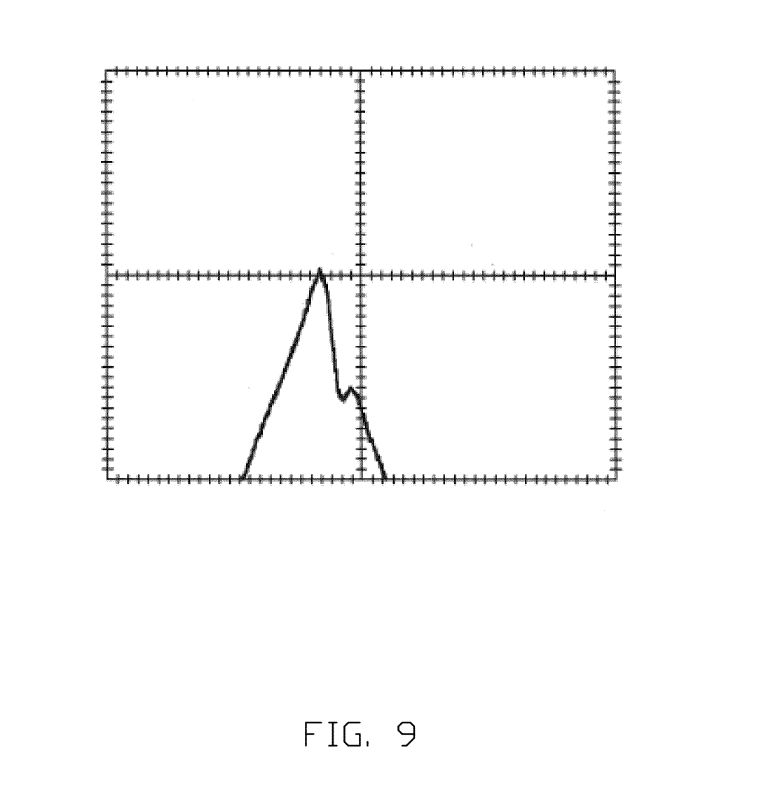

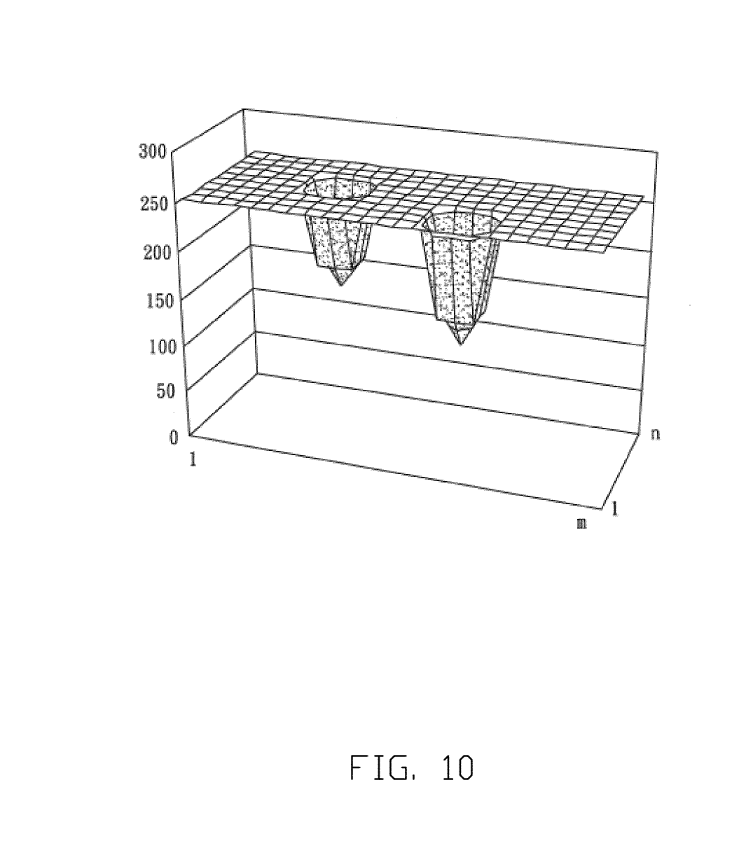

Referring to FIG. 7, a scanning period of one embodiment is shown. During a period T₁, the driving circuit 32 inputs a square signal via scanning line 1, the reading circuit 30 can read each of the voltage values on the Y axis from reading line 1 to reading line n. During a period T₂, the driving circuit 32 inputs a square signal via scanning line 2, the reading circuit 30 can read each of the voltage values on the Y axis from reading line 1 to reading line n. During a period Tₘ, the driving circuit 32 inputs a square signal via scanning line m, the reading circuit 30 can read each of the voltage values on the Y axis from reading line 1 to reading line n. A scanning period is finished after all of the scanning lines from 1 to m have had a square signal input. After one period, m*n voltage values can be obtained. FIG. 8 shows a reading signal wave when the touch panel 200 is untouched. FIG. 9 shows a reading signal wave when the touch panel 200 is touched by user's hand. When the m*n voltage values are treated by a Numerical Statistic method, a curve, shown in FIG. 10, is obtained. The location of the minimum voltage extent represents the location of the touch point. The touch panel 200 and the detecting method of the present disclosure can detect multiple touches at a same time.

It is to be understood that the above-described embodiments are intended to illustrate rather than limit the disclosure. Any element described in accordance with any embodiment can be used in addition to or as a substitute in other embodiments. Embodiments can also be used together. Variations may be made to the embodiments without departing from the spirit of the disclosure. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A capacitance touch panel, comprising:
an insulated substrate comprising a first surface and a second surface opposite to each other;
a first conductive film being electrical resistance anisotropy, and located on the first surface of the insulated substrate; and
a second conductive film being electrical resistance anisotropy, and located on the second surface of the insulated substrate, wherein a minimum electrical resistance direction of the first conductive film is perpendicular to a minimum electrical resistance direction, at least one of the first conductive film and the second conductive film is a carbon nanotube film.

2. The capacitance touch panel of claim 1, wherein the carbon nanotube film comprises a plurality of carbon nanotubes extending along a same direction.

3. The capacitance touch panel of claim 2, wherein the extending direction of the carbon nanotubes is the minimum electrical resistance direction of the carbon nanotube film.

4. The capacitance touch panel of claim 1, wherein the first conductive film comprises a plurality of strip-type conductive structures parallel to and spaced a distance with each other.

5. The capacitance touch panel of claim 4, wherein the plurality of strip-type conductive structures extend along the minimum electrical resistance direction of the first conductive film.

6. The capacitance touch panel of claim 4, wherein a ratio between a width of the strip-type conductive structure and the distance between the adjacent strip-type conductive structures 202 is in a range from about 5% to about 50%.

7. The capacitance touch panel of claim 4, wherein a ratio between a width of the strip-type conductive structure and the distance between the adjacent strip-type conductive structures is in a range from about 10% to about 20%.

8. The capacitance touch panel of claim 4, wherein the first conductive film is a patterned ITO film.

9. The capacitance touch panel of claim 1, wherein the plurality of carbon nanotubes are joined end-to-end along the extending direction by van der Waals attractive force therebetween.

10. The capacitance touch panel of claim 1, further comprising an adhesive layer located between the carbon nanotube film and the insulated substrate.

11. The capacitance touch panel of claim 1, further comprising a protection layer located on the first conductive film.

12. A capacitance touch panel, comprising:
an insulated substrate comprising a first surface and a second surface opposite to each other;
a first conductive film located on the first surface, comprising a plurality of strip-type conductive structures spaced and parallel to each other, wherein the first conductive film is electrical resistance anisotropy, and comprises a minimum electrical resistance direction and a maximum electrical resistance direction perpendicular to the minimum electrical resistance direction, the strip-type conductive structures extend along the minimum electrical resistance direction;
a carbon nanotube film located on the second surface of the insulated substrate via an adhesive, wherein the carbon nanotube film comprises a plurality of carbon nanotubes extending along a same direction, the extending direction of the carbon nanotubes is perpendicular to the extending direction of the strip-type conductive structures; and
a protect layer located on the first conductive film.

13. The capacitance touch panel of claim 12, wherein the carbon nanotube film comprises a plurality of successive and oriented carbon nanotubes joined end-to-end by van der Waals attractive force therebetween along the extending direction.

14. The capacitance touch panel of claim 12, wherein a thickness of the adhesive is in a range from about 4 micrometers to about 8 micrometers.

15. The capacitance touch panel of claim 12, wherein a ratio between a width of the strip-type conductive structure and the distance between the adjacent strip-type conductive structures is in a range from about 5% to about 50%.

16. The capacitance touch panel of claim 12, wherein a ratio between a width of the strip-type conductive structure and the distance between the adjacent strip-type conductive structures is in a range from about 10% to about 20%.

17. The capacitance touch panel of claim 12, wherein the first conductive film is a patterned ITO film.

18. The capacitance touch panel of claim 12, further comprising a reading circuit and a driving circuit, wherein the first conductive film is coupled to the reading circuit; the second conductive film is coupled to the driving circuit.
